(19) United States
(12) Patent Application Publication
(10) Pub. No.: US 2008/0015108 A1
(43) Pub. Date: Jan. 17, 2008

(54) BIAXIALLY ORIENTED LAMINATED POLYESTER FILM FOR TRANSFER APPLICATIONS

(75) Inventors: Satoshi Yamamoto, Warwick, RI (US); Douglas J. Bower, Charlestown, RI (US); Hiroshi Furuya, Narragansett, RI (US); Hideo Yanase, West Warwick, RI (US); Steven Sargeant, Kingston, RI (US)

Correspondence Address: BARLOW, JOSEPHS & HOLMES, LTD., 101 DYER STREET, 5TH FLOOR, PROVIDENCE, RI, 02903, US

(73) Assignee: TORAY PLASTICS (AMERICA), INC., North Kingstown, RI (US)

(21) Appl. No.: 11/775,262

(22) Filed: Jul. 10, 2007

Related U.S. Application Data
(60) Provisional application No. 60/831,272, filed on Jul. 17, 2006.

(51) Int. Cl. B41M 5/035

(52) U.S. Cl. 503/227

(57) ABSTRACT

A biaxially oriented laminated polyester film (10) for transfer applications having a total thickness of from about 2.0 to about 7.0 um, comprising at least a first polyester layer (A layer) (12) forming on one side (A side) a first surface and a second layer (B layer) (16) forming on the other side (B side) a second surface, wherein the A side surface has a first surface roughness and the B side surface has a second surface roughness that is greater than the A side surface roughness.

### CROSS-REFERENCE TO RELATED APPLICATION

This application is related to and claims priority from earlier filed U.S. provisional patent application Ser. No. 60/831,272, filed Jul. 17, 2006 and incorporated herein by reference.

### BACKGROUND

The present disclosure relates to a biaxially oriented laminated polyester film suitable for use in transfer applications generally, and more particularly, in embodiments, for use as a thermal transfer film ribbon. Further, the present disclosure relates, in embodiments, to a biaxially oriented laminated polyester film suitable for use as a dye sublimation thermal transfer ribbon.

Biaxially oriented polyester film, including, for example, polyethylene terephthalate film, polyethylene-2,6-naphthalate film, among others, has many desirable characteristics, including, for example, excellent physical properties, heat stability, physical stability, chemical reagent resistance, cost performance, among others. Therefore, this film is used for a variety of applications which take advantage of its efficiency and other desirable attributes. One such application is as a transfer film, especially a thermal transfer film ribbon, which can be used, for example, to prepare thermal transfer records with thermal transfer ink.

Thermal transfer recording methods generally comprise, for example, providing a thermal transfer ribbon, which can include, for example, a constituted thermal transfer ink layer, a heat resistance backcoat layer, a support film, and a receiver sheet in contact with one another; transferring heat from a thermal print head to print through the backcoat layer of the support film; and forming prints by transferring a molten or a sublimated ink layer. This method affords many advantages, such as cost and performance advantages, is maintenance free, and affords easy handling, among other advantages. For these reasons, this method has been applied facsimile and Barcode applications, and has been used in the digital photo print area, and which is a market that is experiencing remarkable growth.

Dye sublimation thermal transfer methods, using sublimation dye as the thermal transfer ink, can achieve excellent gradation, especially in the area of full color prints. Recently, improvements in available recording media, including sublimation dyes, as well as improvements to the hard printer devices, has enabled the achievement of very detailed prints, having a quality equal to the print quality achievable with silver halide.

Generally, three original colors (yellow, magenta and cyan) are first transferred to the receiver, after which an overcoat layer is transferred to prevent or diminish color fade and to provide water resistance. While increasingly detailed prints have been achieved with dye sublimation thermal transfer methods, it is desirable to improve other print characteristics such as glossiness, and to enhance overall print quality, to achieve a result even more comparable to that achieved using silver halide print processes.

One effort to improve the quality of thermal transfer prints has been directed to restricting the upper limit of the surface roughness of the polyester film used, which film comprises for example, a color layer, a support layer and an overcoat layer, and has been shown to enhance the glossiness of transferred prints. See, for example, Japanese Patent Laid Open, JP-A 2004-306580, which is hereby incorporated by reference herein in its entirety. However, as the surface roughness enhances the glossiness of transferred prints, the windability of the film roll or of the thermal transfer ribbon, as well as the runability or printability of the ribbon are adversely affected by this approach. Efforts to address this issue have included a two layer polyester film which has the surface roughness of both layers selected to improve windability, see, for example, Japanese Patent Laid Open, JP-A 11-321134), which is hereby incorporated by reference herein in its entirety. Another effort has been directed to restricting one side of the surface roughness of a dual layer to enhance printability, see for example Japanese Patent Laid Open 2005-7787, which is hereby incorporated by reference herein in its entirety. Yet another effort has been directed to restricting the specular glossiness of the film surface to provide compatible printability and runability, see for example, Japanese Patent Laid Open, JP-A 2005-238623, which is hereby incorporated by reference herein in its entirety. Still another effort has been directed to selecting different sizes of particles which are included in a mono-layer polyester film, see for example, Japanese Patent Laid Open, JP-A 2006-169466, which is hereby incorporated by reference herein in its entirety. Moreover, U.S. Pat. No. 6,984,424, of Taro Suzuki et al. entitled “Thermally transferable image protective sheet, method for protective layer formation, and record produced by said method,” which is hereby incorporated by reference herein in its entirety, discloses in the Abstract thereof a thermally transferable image protective sheet and a method for protective layer formation that can provide a protective layer which can protect an image of a record produced by a nonsilver photographic color hard copy recording method, can impart lightfastness and other properties to the record, and can realize a record having a glossy impression comparable to silver salt photographs. The thermally transferable image protective sheet comprises a support and a thermally transferable resin layer having a single-layer or multilayer structure stacked on the support so as to be separable from the support. The thermally transferable image protective sheet has been constructed so that, when the thermally transferable image protective sheet is put on top of a print so as for the thermally transferable resin layer to be brought into contact with an image portion in the print and the thermally transferable resin layer is thermally transferred to cover at least the image portion of the print followed by the separation of the support from the thermally transferable image protective sheet to form a thermally transferred resin layer on the surface of the print, the surface of the thermally transferred resin layer on the print has a specular glossiness of not less than 60% as measured at an angle of incidence of 20 degrees according to JIS (Japanese Industrial Standards) Z 8741.

The appropriate components and process aspects of the each of the foregoing Patents and Patent Applications may be selected for the present disclosure in embodiments thereof.

There remains a need to improve the process for preparing films and ribbons for thermal transfer applications as well as a need to improve and enhance the characteristics of thermal transfer film and ribbons. For example, there remains a need to address issues related to winding wide and lengthy film rolls and there further remains a need to improve thermal transfer ribbon productivity when manufacturing same. There remains a need for improvements to conventional production methods, which are largely directed to winding narrow, shorter film rolls, and which do not address issues related to windability and other components when preparing wider, longer films.

### SUMMARY OF THE INVENTION

The present disclosure addresses the above and other issues. For example, the present disclosure provides, in embodiments, a method for preparing a thermal transfer film and a thermal transfer ribbon providing high print glossiness and excellent windability, for example, in embodiments, for producing a wider and longer film roll simultaneously, and in further embodiments for supplying biaxially oriented laminated polyester film for transfer applications.

In embodiments, a biaxially oriented laminated polyester film for transfer applications is disclosed having a total thickness of from about 2.0 to about 7.0 um, comprising at least a first polyester layer (A layer) forming on one side (A side) a first surface and a second layer (B layer) forming on the other side (B side) a second surface, wherein the A side surface has a first surface roughness and the B side surface has a second surface roughness that is greater than the A side surface roughness.

The present disclosure provides, in embodiments, a biaxially oriented laminated polyester film for transfer application characterized by, in embodiments, a total thickness of from about 2.0 to about 7.0 micrometers (um), comprising, in embodiments, at least a first polyester layer (A layer) forming one side (A side) having a first surface and a second layer (B layer) forming on the other side (B side) having a second surface, and satisfying, in embodiments, the following relationships:

6≦SRaA≦18;

30≦SRaB≦70;

4≦SRpA/SPcA≦12;

2.0≦udAA/udAB≦4.0;

wherein SRaA represents the three dimensional central plane average roughness (nm) of the A side first surface, SRaB represents the three dimensional central plane average roughness (nm) of the B side second surface, SRpA is the three dimensional central plane maximum height (nm) of the A side surface, SPcA is the peak count of particles protruding from the A side surface, udAA is the dynamic coefficient of friction between the A sides of two adjacent A layers, and udAB is the dynamic coefficient of friction between the A side and the B side.

In further embodiments, the following relationships are selected:

0.5≦dA≦1.2;

0.02≦cA≦0.06;

2.0≦dB≦3.5;

0.20≦cB≦0.35;

2.0≦dA/dB≦6.0;

wherein dA is the inert particle average diameter for particles comprising the A layer, cA is the inert particle content by weight with respect to the total weight of the A layer, dB is the inert particle average diameter for particles comprising the B layer, cB is the inert particle content by weight with respect to the total weight of the B layer. In embodiments, it can be selected that the F-5 value in the longitudinal direction of the film is about 115 to about 145 MPa. In embodiments, the heat shrinkage in the transverse direction of the film is selected in the range of about −1.0 to about +1.0%, measured at about 150 degrees Celsius for about 30 minutes.

In embodiments of the present disclosure, a biaxially oriented laminated polyester film suitable for transfer application is selected to have a lamination structure, surface roughness, dynamic coefficient of friction, and a thickness as described, to achieve higher glossiness of prints and excellent windability than previously available. These characteristics are achieved, in embodiments, for films that are both wide and long at the side time. As used herein, wide means, for example, having a width of from about 1 to about 1.8 meters, and long means, for example, having a length of from about 10 to about 60 kilometers.

In embodiments, the average diameter and content of inert particles selected for the various film layers are selected as described to achieve the surface roughness and printabilty effects as desired. Additionally, in embodiments, the F-5 value in the longitudinal direction of the film is selected to achieve excellent runability when using the films as ink ribbon. Moreover, in embodiments, the heat shrinkage in the transverse direction of the film is restricted, consequently providing good treatability, for example, when producing ink ribbon.

### BRIEF DESCRIPTION OF THE DRAWINGS

FIG. 1 is a schematic illustration of an embodiment of a film in accordance with the present disclosure.

FIG. 2 is a Table showing characteristic test results for films made in accordance with the present disclosure and for comparative films.

### DETAILED DESCRIPTION

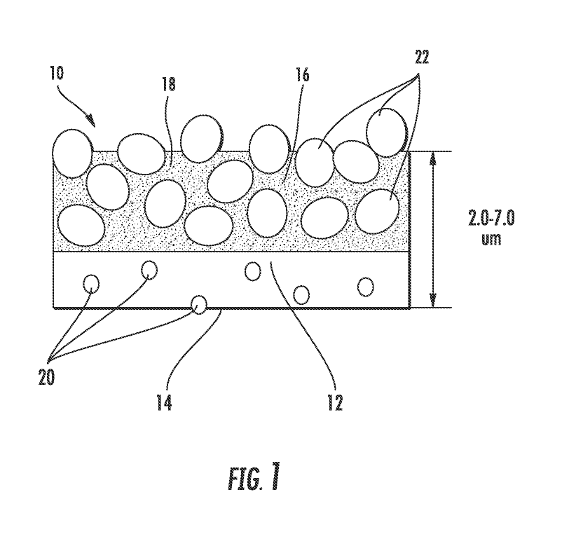

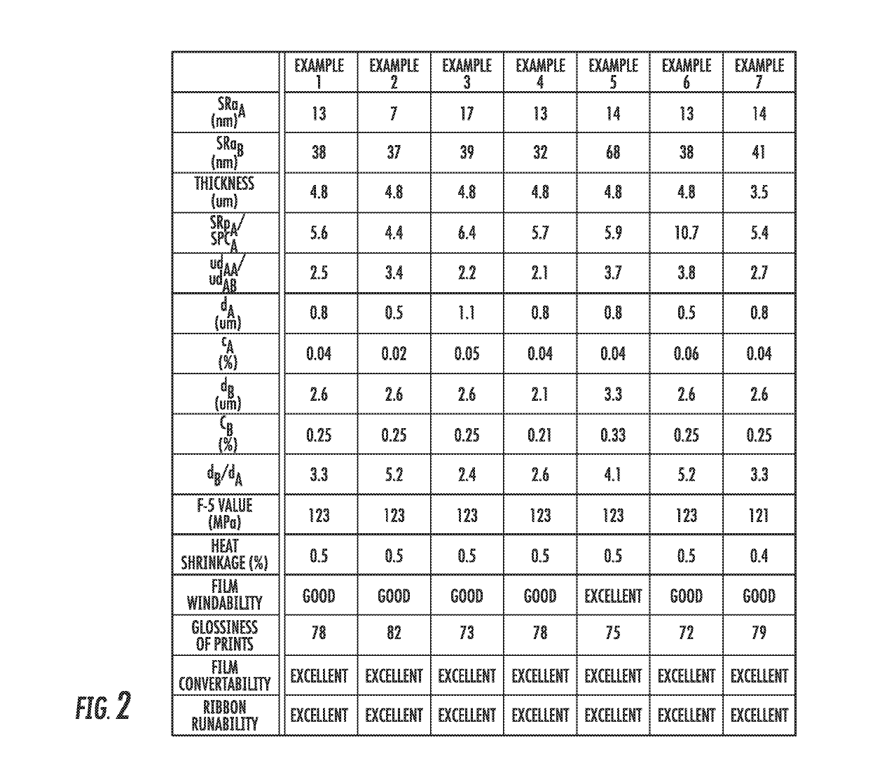

In embodiments, a biaxially oriented laminated polyester film for transfer applications is disclosed having a total thickness of from about 2.0 to about 7.0 um, comprising at least a first polyester layer (A layer) forming on one side (A side) a first surface and a second layer (B layer) forming on the other side (B side) a second surface, wherein the A side surface has a first surface roughness and the B side surface has a second surface roughness that is greater than the A side surface roughness. FIG. 1 illustrates a film 10 having a first layer A 12 having a first surface 14 comprising a smooth surface and a second layer B 16 having a second surface 18 comprising a rough surface. Layer A comprises particles 20 and layer B comprises particles 22. Particles 20 and 22 are selected, in embodiments, as described herein, to provide desired characteristics to the various film layers, for example desired surface roughness characteristics.

The polyester suitable for use in the present disclosure can be any suitable material and is, in embodiments, is a polymer prepared from a diol and a dicarboxylic acid by condensation polymerization. The dicarboxylic acid is represented, for example, by terephthalic acid, isophthalic acid, phthalic acid, naphthalene dicarboxylic acid, adipic acid, sebacic acid, etc., but not limited thereto. The diol is represented, for example, by ethylene glycol, trimethylene glycol, tetramethylene glycol, cyclohexanedimethanol, etc., but not limited thereto. Specific examples of suitable materials are polyesters selected from the group consisting of polymethylene terephthalate, polyethylene terephthalate, polypropylene terephthalate, polyethylene isophthalate, polytetramethylene terephthalate, poly-1,4-cyclohexylenedimethylene terephthalate and poly-2,6-naphtalate, and mixtures and combinations thereof, although not limited to these materials. These polyesters may be either homopolymers or copolymers. As the copolymerization component, for example, a diol component such as diethylene glycol, neopentyl glycol or polyalkylene glycol, or a dicarboxylic component such as adipic acid, sebacic acid, isophthalic acid, phthalic acid or 2,6-naphthalene dicarboxylic acid can be used, among others. In embodiments, at least one material is selected from the group consisting of polyethylene terephthalate, polypropylene terephthalate, polyethylene isophthalate, polyethylene-2,6-naphthalate and copolymer thereof, which provide, in embodiments, desirable mechanical strength, thermal resistance, chemical resistance and durability.

The biaxially oriented polyester film of the present disclosure has, in embodiments, at least a dual layer structure with the A layer forming on one side (A side) a first surface and the B layer forming on the other side (B side) a second surface. The disclosure provides, in embodiments, film and film ribbon providing excellent film windability and high gloss prints not attainable with previously available mono layer structured films. Triple layer film structures having a C layer disposed between the A and B layers, or multi layer structures are also provided herein, in embodiments. The present dual or multi layer film structures can be produced in the line as described below.

In embodiments, the biaxially oriented polyester film of the present disclosure satisfies the following relationships:

6≦SRaA≦18;

30≦SRaB≦70;

wherein SRaA represents the three dimensional central plane average roughness (nm) of the A side surface, SRaB represents the three dimensional central plane average roughness (nm) of the B side surface.

In embodiments, characteristics are selected to satisfy the following relationships:

8≦SRaA≦;16

35≦SRaB≦65;

When the SRaA value is smaller than about 6, or the SRaB value is smaller than about 30, the windability of the film roll deteriorates. On the other hand, when the SRaA value is larger than about 18, or the SRaB value is larger than about 70, the high gloss characteristic of the prints is adversely affected.

In embodiments, the biaxially oriented polyester film of the present disclosure satisfies the following relationships:

4≦SRpA/SPcA≦12;

wherein SRpA is the three dimensional central plane maximum height (nm) of the A side surface, SPcA is the peak count of particles comprising the A side surface.

In embodiments, the film is selected to satisfy the following relationships:

5≦SRpA/SPcA≦10.

When the SRpA/SPcA value is smaller than about 4, the windability of the film deteriorates. On the other hand, when the SRpA/SPcA value is larger than about 12, the high gloss characteristic of the prints is adversely affected.

In embodiments, the biaxially oriented polyester film of the present disclosure satisfies the following relationships:

2.0≦udAA/udAB≦4.0;

wherein udAA is the dynamic coefficient of friction between two A sides, and udAB is the dynamic coefficient of friction between the A side and the B side.

In embodiments, the film herein satisfies the following relationships:

2.2≦udAA/udAB≦3.8.

When the udAA/udAB value is smaller than about 2.0, the windability of the film deteriorates. On the other hand, when the udAA/udAB value is larger than 4.0, the desired high glossiness of the prints cannot be achieved.

The thickness of the laminated film is selected, in embodiments at from about 2.0 to about 7.0 um, or from about 3.0 to about 6.0 um. When the thickness of the film is smaller than about 2.0 um, thermal properties, mechanical properties, or a combination thereof, deteriorate. On the other hand, when the thickness of the film is larger than about 7.0 um, the heat sensitivity of the film deteriorates because of the need to increase the energy of thermal heads. The ribbon length can be selected at shorter lengths, in embodiments.

In order to realize the surface roughness and dynamic coefficient of friction coefficient characteristics described herein, the average particle diameter or the content of the inert particles are selected accordingly. Further, the stretch draw ratio or treatment temperature during producing biaxially oriented film can be selected to achieve or enhance the desired properties. Inorganic or organic particles, such as colloidal silica, cohesive silica, alumina, calcium carbonate, kaolin, cross-linked polystyrene or silicone particle can be added in order to enhance film windability. In the present disclosure, by satisfying the following relationships, desirable surface roughness and dynamic friction coefficient criteria as described herein are readily achieved:

0.5≦dA≦1.2;

0.02≦cA≦0.06;

2.0≦dB≦3.5;

0.20≦cB≦0.35;

2.0≦dA/dB≦6.0;

wherein dA is the inert particle average diameter of particles comprising the A layer, cA is the inert particle content by weight with respect to the total weight of the A layer, dB is the inert particle average diameter of particles comprising the B layer, cB is the inert particle content by weight with respect to the total weight of the B layer.

In embodiments, the material is selected so as to satisfy the following relationships, providing, in embodiments, the surface roughness and dynamic friction coefficient described before:

0.6≦dA≦1.1;

0.03≦cA≦0.05;

2.2≦dB≦3.2;

0.22≦cB≦0.32;

2.5≦dA/dB≦5.5.

Additionally, in the present disclosure, the runability of the thermal transfer ribbon is improved by, in embodiments, restricting the F-5 value in the longitudinal direction of the film, and further, in various embodiments, by restricting or selecting, the lamination structure, surface roughness, dynamic coefficient of friction for the two or more layers, film layer thickness, average particle diameter and content of particles, or mixtures and combinations thereof. In embodiments, an F-5 value in the longitudinal direction of the film is desirably selected at from about 115 to about 145 MPa, or from about 120 to about 140 MPa. When the F-5 value is smaller than about 115 MPa, runability deteriorates, such as, for example, adverse events such as wrinkles occur easily in the case of using as the thermal transfer ribbon. On the other hand, when the F-5 value is larger than about 145 MPa, productivity deteriorates.

Moreover, in the present disclosure, in embodiments, film treatability is improved by, in embodiments, restricting the heat shrinkage in the transverse direction of the film, selecting the lamination structure, surface roughness, dynamic coefficients of friction, film thickness, and average particle diameter and particle content, and mixtures and combinations of these. The heat shrinkage in the transverse direction of the film is desirably in the range of from about −1.0 to about +1.0%, measured at about 150 degrees for about 30 minutes, or from about −0.8 to about +0.8%, measured at about 150 degrees for about 30 minutes. When the heat shrinkage is lower than about −1.0%, productivity deteriorates. When the heat shrinkage is higher than about +1.0%, film treatability deteriorates, for example, wrinkles occur on the moving path during inking and winding becomes more difficult.

In embodiments, the films described above may advantageously be prepared by the following method. The thermoplastic resins (A and B) can be separately extruded and after the extrusion and before the solidification, the extruded thermoplastic resin sheets are laminated by using a multilayered manifold or a cofluency block. In embodiments, it is desirable to provide a static mixer or gear pump on the moving path of the thermoplastic resin for attaining the desired relationship between the thickness of each layer. The laminated sheet is cooled and solidified on the casting drum, which surface is from about 20 to about 70 degrees Celsius to obtain a laminated non-oriented film. The thus prepared non-oriented laminated film is then stretched in the longitudinal direction from about 5.9 to about 6.5 times at a temperature of from about 80 to about 130 degrees Celsius in the first stretching process. In order to realize an F-5 value in the range of from about 115 to about 145 MPa in the longitudinal direction of the film, the stretch draw ratio is selected at higher than about 5.9 times, and to realize an F-5 value in the range of from about 120 to about 140 MPa in the longitudinal direction of the film, the stretch draw ratio is selected at about 6.0 to about 6.4 times.

The stretching in the transverse direction is, in embodiments, conducted by using a tenter. The film is preheated to about 100 to about 130 degrees Celsius, and then stretched in the transverse direction from about 3.5 to about 4.5 times as the second stretching process. The thus prepared biaxially stretched film is then heat treated at a temperature of from about 220 to about 240 degrees Celsius. It is also possible for the film to be stretched again in the longitudinal direction, the transverse direction or both longitudinal and transverse direction to enhance the mechanical strength before heat setting if desired. After heat treating, the film was made to relax in the transverse direction from about 3 to about 7% under about 150 to about 185 degrees Celsius, and at last the biaxially oriented laminated polyester film of the present disclosure may be in the form of a roll. In order to realize the heat shrinkage in the range of about −1.0 to about +1.0% in the transverse direction of the film, where it is measured at about 150 degrees Celsius for about 30 minutes, a heat setting temperature is in embodiments, selected in the range of from about 220 to about 240 degrees Celsius and the relaxation ratio in the transverse direction is, in embodiments, selected in the range of from about 3 to about 7%. Moreover, to realize the heat shrinkage in the range of from about −0.8 to about +0.8% in the transverse direction of the film, where it is measured at about 150 degrees Celsius for about 30 minutes, the heat setting temperature is selected, in embodiments, in the range of about from 225 to about 235 degrees Celsius and the relaxation ratio in the transverse direction is, in embodiments, selected in the range of from about 4 to about 6%.

The present films may produced by any suitable method and production thereof is not restricted as described before. For example, the stretching order of longitudinal direction and transverse direction could be replaceable, and it is further possible to utilize a simultaneous biaxial drawing method instead of a conventional successive biaxial drawing method.

In the case of using the films herein as thermal transfer film ribbon, particularly dye sublimation thermal transfer ribbon, in embodiments, an adhesive layer may be provided on the surface of inking side (A side) from the viewpoint of improving the adhesion between ink layer and polyester film. The adhesive layer is desirably formed of a thermoplastic resins such as polyester resins, acrylic resins and so on. The adhesive layer may also contain cross-linking agents or other additives, and these resins can be dissolved in water or organic solvents such as methyl ethyl ketone, acetone or toluene, among others.

An optional heat resistant slip layer, comprising for example, wax derivatives or silicone derivatives, may be provided on the support on a side remote from the thermally transferable resin layer from the viewpoint of avoiding sticking caused by heat from the thermal head during printing. These treatments can be done during or after producing the biaxially oriented polyester film. Well-known coating equipment, such as gravure coaters, roll coaters or rod coaters can be utilized, among other methods can be used.

Coating a thermal transfer ink, particularly dye sublimation thermal transfer ink, onto the inking side of the thus treated biaxially oriented polyester film, thermal transfer ribbon, particularly dye sublimation thermal transfer ribbon, can be accomplished in embodiments. Well-known ink, particularly sublimation dye, can be employed, and generally ink can be dissolved in organic solvents described before, and then coated, although other methods can be used.

The biaxially oriented laminated polyester film of the present disclosure can be used, in embodiments, as a biaxially oriented laminated polyester film for transfer applications so as to realize high glossiness of prints as well as excellent film windability even with films that are both wide and long simultaneously. Particularly, the biaxially oriented laminated polyester film of the present disclosure can be used as biaxially oriented laminated polyester film for thermal transfer ribbon, more particularly, for dye sublimation thermal transfer ribbon so as to achieve good treatability during inking and runability of thermal transfer ribbon additionally.

### EXAMPLES AND COMPARATIVE EXAMPLES

The following Examples are being submitted to further define various species of the present disclosure. These Examples are intended to be illustrative only and are not intended to limit the scope of the present disclosure. Also, parts and percentages are by weight unless otherwise indicated.

Various physical property values and characteristic properties in the present disclosure were measured and defined as follows.

(1) Three Dimensional Central Plane Average Roughness (SRa), Three Dimensional Central Plane Height (Srp) and Particle Peak Counts (SPc)

Surface roughness of the film was measured by a tracer type three-dimensional surface roughness tester (ET-30HK by Kosaka Kenkyusyo) under conditions of 0.5 um needle radius and 10 mg in load at the cut-off value of 0.25 mm along the transverse direction of the film over 0.5 mm in the length of measurement. Such measurement was made along the longitudinal direction of the film continuously by 80 times at the intervals of 5 um.

SRa and SRp are values defined in JIS-B0601. SPc is determined as follows. A peak count level was determined at the level of separating 0.01 um from average line of surface roughness curve in parallel. Between two intersection points of roughness curve and average line, and roughness curve and peak count level, one peak was defined when existing one intersection point of roughness curve and peak count level. These peaks were counted within the measure length 10 times, and an average value was calculated.

(2) Dynamic Coefficient Friction

A glass plate was fixed under a set of two films, a lower film (film in contact with the glass plate) of the set was pulled with a low-speed roll (10 cm/min), and a detector fixed at one end of an upper film (at the opposite end in the pulling direction of the lower film) to detect initial tensile force between the films. A sled having a weight of 1 kg and a lower area of 100 cm² was used. The dynamic friction of coefficient (ud) was obtained from the following equation:

ud=tensile force during sliding (kg)/load of 1 kg

(3) Film Thickness

Ten films were placed one upon another in such a manner that dust was not be inserted therebetween, and the total thickness of the films measured by an intermittent electronic micrometer to calculate the thickness of each film.

(4) Average Diameter of Inert Particles

The average particle diameter was measured by using a Centrifugal Size Analyzer Type CP-50 manufactured by Shimadzu Corp. The particle diameter corresponding to 50 mass % was read from a cumulative curve showing the relationship between the particle diameter and the residual amount of the particles calculated based upon the obtained centrifugal precipitation curve, and the diameter was used as the average particle diameter.

(5) Content of Inert Particles

The amount of particles was determined by burning 50 grams of polyester film before recovery in a platinum crucible in an oven heated to about 1000 degrees for 3 hours, mixing the burnt residue in the crucible with powder terephthalic acid to form a tablet-formed plate of 50 grams weight, subjecting the tablet to wavelength dispersive fluorescent X-ray spectroscopy, and converting the obtained count of each element into the addition amount by using a calibration curve prepared beforehand. The X-ray output was set to 4 KW.

(6) F-5 Value

Using an Instron type tensile tester, a sample film was tensed at a width of 10 mm, a distance between clips of 100 mm and a tensile speed of 200 mm/min. In the tension-strain curve obtained, a tension at a position of 5% elongation is defined as the F-5 value. The test was performed in an atmosphere having a temperature of about 25 degrees Celsius and a humidity of about 65% RH.

(7) Heat Shrinkage

This measurement was carried out in accordance with JIS-C2318.

Sample size: width 10 mm, marked line interval 200 mm

Measurement condition: temperature 150 degrees Celsius, processing time 30 min, unloaded

Heat shrinkage was calculated by the following equation.

Heat shrinkage (%)=(L0−L)/L0*100

L0: marked line interval before heating

L: marked line interval after heating

(8) Film Windability

30,000 meters length of film roll slit to 1,500 millimeters width was wound on plastic core under a tension of 15 KG and a speed of 300 meters/min. Film windability was evaluated by the following criterion.

Excellent: No wrinkle occurred both in the beginning of and in the middle of winding.

Good: Wrinkles occurred in the beginning of winding but disappeared soon.

Poor: Wrinkles occurred in the beginning of and in the middle of winding, and did not disappear.

(9) Glossiness of Prints

At first, heat resistance slip layer having a following composition was coated on B side at a coverage of 1.0 g/m² on a dry basis.

| | |
|---|---|
| Acrylic acid ester: | 70 parts by weight |
| Amino denaturated silicone: | 29 parts by weight |
| Isocyanate: | 1 parts by weight |

After that, adhesive layer having a following composition was coated on A side at a coverage of 1.5 g/m² on a dry basis.

| | |
|---|---|
| Polyester resin: | 18 parts by weight |
| Benzotriazole ultraviolet absorber: | 2 parts by weight |
| Methyl ethyl ketone: | 40 parts by weight |
| Toluene: | 40 parts by weight |

Moreover, overcoat layer having the following composition was coated onto adhesive layer at a coverage of 1.0 g/m² on a dry basis.

| | |
|---|---|
| Styrene-acryl copolymer resin: | 30 parts by weight |
| Methyl ethyl ketone: | 35 parts by weight |
| Toluene: | 35 parts by weight |

A full density blotted image was printed on a receiver sheet with a dye sublimation printer UP-D 70A manufactured by Sony Co., 100 mm width and 150 mm length. Glossiness of prints thus prepared was measured with a gloss meter mirror-TR1-glosschecker manufactured by BYK-Gardner Inc., at an angle of incidence of 20 degrees according to JIS Z-8741. Glossiness was defined excellent when the value was no less than 70.

(10) Film Convertability into Thermal Transfer Ribbon

During inking described as (9), the status of moving film on path line and winding film on winder were observed and evaluated by the following criterion.

Excellent: No wrinkle occurred during moving on path line and winding on winder.

Good: No wrinkle occurred during moving on path line but during winding wrinkles occurred.

Acceptable: Wrinkles occurred during moving on path line and it became difficult to wind film on winder.

(11) Runability of Thermal Transfer Ribbon

During test printing described as (9), the status of contacting between ribbon and thermal head and prints quality were observed and evaluated by the following criterion.

Excellent: No sticking between ribbon and thermal head, and no wrinkle occurred during printing.

Good: No sticking between ribbon and thermal head, but wrinkles occurred during printing.

Acceptable: Sticking between ribbon and thermal head occurred and uneasy to proceed to print.

### Example 1

0.04 parts by weight cross-linked polystyrene particles having an average diameter of 0.8 um, manufactured by Toray Industries, Inc. were added to 100 parts by weight polyethylene terephthalate having an inherent viscosity of 0.6, manufactured by Toray Industries, Inc. (Polymer A) 0.25 parts by weight silica dioxide particles having an average diameter of 2.6 um, manufactured by Toray Industries, Inc. were added to the polyethylene terephthalate, having an inherent viscosity of 0.6, manufactured by Toray Industries, Inc. (Polymer B) These polymers were supplied to each extruder and melted at 280 degrees Celsius. The molten polymers were joined in a T-die with combinations of 100 parts by weight of polymer A and 30 parts by weight of polymer B, and the polymer sheet was cast on a rotating cooling drum having a temperature of 20 degrees Celsius to prepare non-stretched laminated film.

The non-stretched film was introduced into a plurality of heated rollers and stretched at a draw ratio of 6.2 times under 125 degrees Celsius in a longitudinal stretching process. The film was introduced into a tenter which grasps both end positions of film by clips, and therein the film was stretched in the transverse direction at a temperature of 115 degrees Celsius and a draw ratio of 4.0 times. After that, the film was heat treated at 230 degrees Celsius and relaxed 4.5% by length in the transverse direction, obtaining biaxially oriented polyester film with 4.8 um thickness.

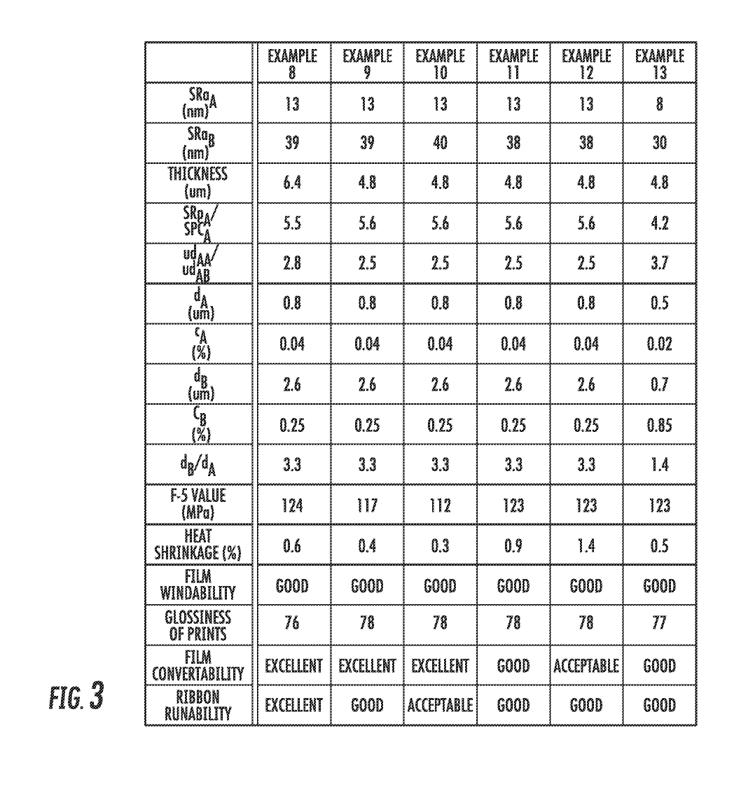

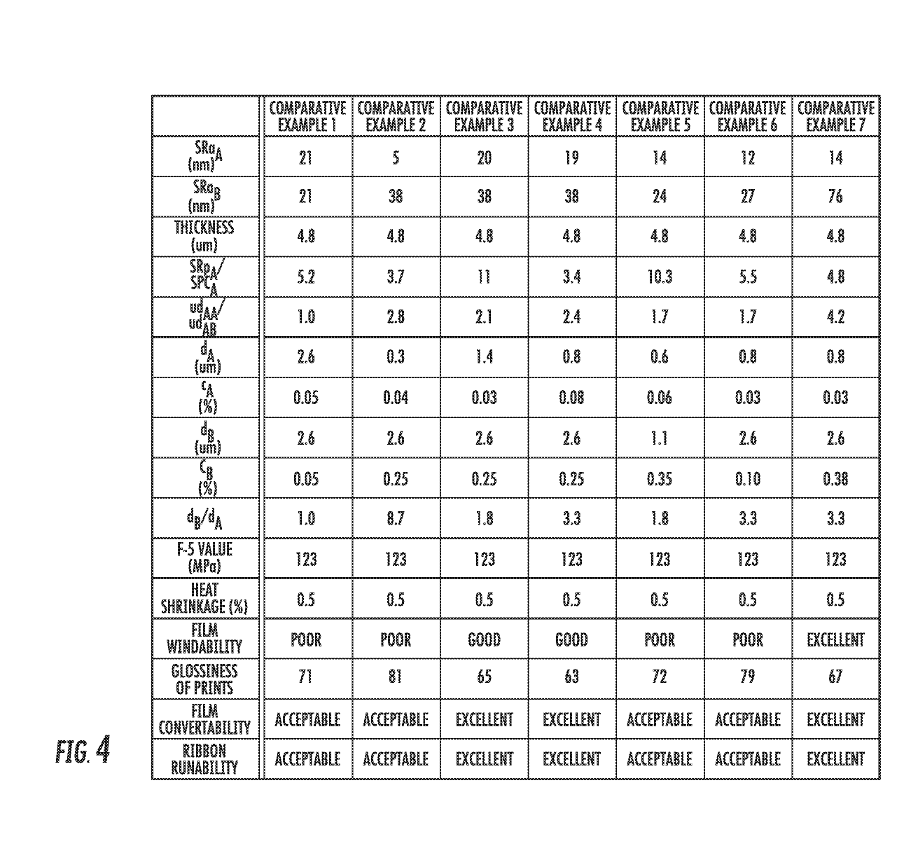

Three dimensional surface roughness, Dynamic coefficient of friction, F-5 value and heat shrinkage of the film were measured, and slit in a narrow width to evaluate windability. Further, preparing a dye sublimation thermal transfer ribbon, treatability during inking, runability of thermal transfer ribbon and glossiness of prints were evaluated. The measurement results of characteristic properties of the film are shown in FIG. 2.

### Example 2

A film and a dye sublimation thermal transfer ribbon were obtained in the same manner as Example 1, with the exception that 0.02 parts by weight cross-linked polystyrene particles having an average diameter of 0.5 um, manufactured by Toray Industries, Inc. were added to 100 parts by weight of polyethylene terephthalate having an inherent viscosity of 0.6, manufactured by Toray Industries, Inc. (Polymer A) The measurement results of characteristic properties of the film are shown in FIG. 2.

### Example 3

A film and a dye sublimation thermal transfer ribbon were obtained in the same manner as Example 1, except that 0.05 parts by weight calcium carbonate particles having an average diameter of 1.1 um, manufactured by Toray Industries, Inc. were added to 100 parts by weight polyethylene terephthalate having an inherent viscosity of 0.6, manufactured by Toray Industries, Inc. (Polymer A) The measurement results of characteristic properties of the film are shown in FIG. 2.

### Example 4

A film and a dye sublimation thermal transfer ribbon were obtained in the same manner as Example 1, except that 0.21 parts by weight silica dioxide particles having an average diameter of 2.1 um, manufactured by Toray Industries, Inc. were added to 100 parts by weight polyethylene terephthalate having an inherent viscosity of 0.6, manufactured by Toray Industries, Inc. (Polymer B) The measurement results of characteristic properties of the film are shown in FIG. 2.

### Example 5

A film and a dye sublimation thermal transfer ribbon were obtained in the same manner as Example 1, except that 0.33 parts by weight silica dioxide particles having an average diameter of 3.3 um, manufactured by Toray Industries, Inc. were added to 100 parts by weight polyethylene terephthalate having an inherent viscosity of 0.6, manufactured by Toray Industries, Inc. (Polymer B) The measurement results of characteristic properties of the film are shown in FIG. 2.

### Example 6

A film and a dye sublimation thermal transfer ribbon were obtained in the same manner as Example 1, except that 0.06 parts by weight cross-linked polystyrene particles having an average diameter of 0.5 um, manufactured by Toray Industries, Inc. were added to 100 parts by weight polyethylene terephthalate having an inherent viscosity of 0.6, manufactured by Toray Industries, Inc. (Polymer A) The measurement results of characteristic properties of the film are shown in FIG. 2.

### Example 7

A film and a dye sublimation thermal transfer ribbon were obtained in the same manner as Example 1 except that a obtaining biaxially oriented polyester film thickness of 3.5 um was selected. The measurement results of characteristic properties of the film are shown in FIG. 2.

### Example 8

A film and a dye sublimation thermal transfer ribbon were obtained in the same manner as Example 1 except that a biaxially oriented polyester film having a film thickness of 6.4 um was selected. The measurement results of characteristic properties of the film are shown in FIG. 2.

### Example 9

A film and a dye sublimation thermal transfer ribbon were obtained in the same manner as Example 1 but with stretching at a draw ratio of 5.9 times in a longitudinal stretching process. The measurement results of characteristic properties of the film are shown in FIG. 2.

### Example 10

A film and a dye sublimation thermal transfer ribbon were obtained in the same manner as Example 1 but with stretching at a draw ratio of 5.5 times in a longitudinal stretching process. The measurement results of characteristic properties of the film are shown in FIG. 2.

### Example 11

A film and a dye sublimation thermal transfer ribbon were obtained in the same manner as Example 1, except that the film was heat treated at 223 degrees Celsius and relaxed 3.8% by length in the transverse direction. The measurement results of characteristic properties of the film are shown in FIG. 2.

### Example 12

A film and a dye sublimation thermal transfer ribbon were obtained in the same manner as Example 1, except that the film was heat treated at 216 degrees Celsius and relaxed 2.5% by length in the transverse direction. The measurement results of characteristic properties of the film are shown in FIG. 2.

### Example 13

A film and a dye sublimation thermal transfer ribbon were obtained in the same manner as Example 1, with the exceptions that 0.02 parts by weight cross-linked polystyrene particles having an average diameter of 0.8 um, manufactured by Toray Industries, Inc. were added to 100 parts by weight of polyethylene terephthalate having an inherent viscosity of 0.6, manufactured by Toray Industries, Inc. (Polymer A) and, 0.50 parts by weight cross-linked polystyrene particles having an average diameter of 0.3 um, manufactured by Toray Industries, Inc. and 0.35 parts by weight calcium carbonate particles having an average diameter of 1.1 um, manufactured by Toray Industries, Inc., that is, totally 0.85 parts by weight particles having an average diameter of 0.7 um were added to 100 parts by weight polyethylene terephthalate having an inherent viscosity of 0.6, manufactured by Toray Industries, Inc. (Polymer B) The measurement results of characteristic properties of the film are shown in FIG. 2.

### Comparative Example 1

A film and a dye sublimation thermal transfer ribbon were obtained in the same manner as Example 1 while changing from a dual extrusion and laminated film to a single extrusion and monolayer film. 0.35 parts by weight silica dioxide particles having an average diameter of 2.6 um, manufactured by Toray Industries, Inc. were added to 100 parts by weight polyethylene terephthalate having an inherent viscosity of 0.6, manufactured by Toray Industries, Inc. The measurement results of characteristic properties of the film are shown in FIG. 2.

### Comparative Example 2

A film and a dye sublimation thermal transfer ribbon were obtained in the same manner as Example 1, except with 0.04 parts by weight cross-linked polystyrene particles having an average diameter of 0.3 um, manufactured by Toray Industries, Inc. were added to 100 parts by weight polyethylene terephthalate having an inherent viscosity of 0.6, manufactured by Toray Industries, Inc. (Polymer A) The measurement results of characteristic properties of the film are shown in FIG. 2.

### Comparative Example 3

A film and a dye sublimation thermal transfer ribbon were obtained in the same manner as Example 1, except 0.04 parts by weight silica dioxide particles having an average diameter of 1.4 um, manufactured by Toray Industries, Inc. were added to 100 parts by weight polyethylene terephthalate, having an inherent viscosity of 0.6, manufactured by Toray Industries, Inc. (Polymer A) The measurement results of characteristic properties of the film are shown in FIG. 2.

### Comparative Example 4

A film and a dye sublimation thermal transfer ribbon were obtained in the same manner as Example 1, except 0.08 parts by weight cross-linked polystyrene particles having an average diameter of 0.8 um, manufactured by Toray Industries, Inc. were added to 100 parts by weight polyethylene terephthalate having an inherent viscosity of 0.6, manufactured by Toray Industries, Inc. (Polymer A) The measurement results of characteristic properties of the film are shown in FIG. 2.

### Comparative Example 5

A film and a dye sublimation thermal transfer ribbon were obtained in the same manner as Example 1, except 0.35 parts by weight calcium carbonate particles having an average diameter of 1.1 um, manufactured by Toray Industries, Inc. were added to 100 parts by weight polyethylene terephthalate having an inherent viscosity of 0.6, manufactured by Toray Industries, Inc. (Polymer B) This film is Lumirror 4XN36H, manufactured by Toray Industries, Inc. The measurement results of characteristic properties of the film are shown in FIG. 2.

### Comparative Example 6

A film and a dye sublimation thermal transfer ribbon were obtained in the same manner as Example 1, except 0.10 parts by weight silica dioxide particles having an average diameter of 2.6 um, manufactured by Toray Industries, Inc. were added to 100 parts by weight polyethylene terephthalate, having an inherent viscosity of 0.6, manufactured by Toray Industries, Inc. (Polymer B). The measurement results of characteristic properties of the film are shown in FIG. 2.

### Comparative Example 7

A film and a dye sublimation thermal transfer ribbon were obtained in the same manner as Example 1, except 0.38 parts by weight silica dioxide particles having an average diameter of 2.6 um, manufactured by Toray Industries, Inc. were added to 100 parts by weight polyethylene terephthalate having an inherent viscosity of 0.6, manufactured by Toray Industries, Inc. (Polymer B) The measurement results of characteristic properties of the film are shown in FIG. 2.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A biaxially oriented laminated polyester film for transfer applications having a total thickness of from about 2.0 to about 7.0 um, comprising at least a first polyester layer (A layer) forming on one side (A side) a first surface and a second layer (B layer) forming on the other side (B side) a second surface, wherein the A side surface has a first surface roughness and the B side surface has a second surface roughness that is greater than the A side surface roughness.

2. A biaxially oriented laminated polyester film for transfer applications having a total thickness of from about 2.0 to about 7.0 um, comprising at least a first polyester layer (A layer) forming on one side (A side) a first surface and a second layer (B layer) forming on the other side (B side) a second surface, and satisfying the following relationships:
6≦SRaA≦18;
30≦SRaB≦70;
4≦SRpA/SPcA≦12;
2.0≦udAA/udAB≦4.0;
wherein SRaA represents the three dimensional central plane average roughness (nm) of the A side surface, SRaB represents the three dimensional central plane average roughness (nm) of the B side surface, SRpA is the three dimensional central plane maximum height (nm) of the A side surface, SPcA is a peak count of particles comprising the A side surface, udAA is a dynamic friction coefficient contacting between both A sides, and udAB is a dynamic friction coefficient contacting between the A side and the B side.

3. The biaxially oriented laminated polyester film for transfer application of claim 2, satisfying the following relationships:
0.5≦dA≦1.2;
0.02≦cA≦0.06;
2.0≦dB≦3.5;
0.20≦cB≦0.35;
2.0≦dA/dB≦6.0;
wherein dA is an inert particle average diameter of particles comprising the A layer; cA is an inert particle content by weight with respect to a total weight of the A layer, dB is an inert particle average diameter of particles comprising the B layer; and cB is an inert particle content by weight with respect to the total weight of the B layer.

4. The biaxially oriented laminated polyester film for transfer application of claim 2, wherein an F-5 value in the longitudinal direction of the film is selected at from about 115 to about 145 MPa.

5. The biaxially oriented laminated polyester film for transfer application of claim 2, wherein a heat shrinkage value in the transverse direction of the film is selected in a range of about −1.0 to about +1.0%, measured at about 150 degrees Celsius for about 30 minutes.

6. The biaxially oriented laminated polyester film of claim 2, wherein the film comprises a base film for a thermal transfer ribbon.

7. The biaxially oriented laminated polyester film of claim 3, wherein the film comprises a base film for a thermal transfer ribbon.

8. The biaxially oriented laminated polyester film of claim 4, wherein the film comprises a base film for a thermal transfer ribbon.

9. The biaxially oriented laminated polyester film of claim 5, wherein the film comprises a base film for a thermal transfer ribbon.

10. The biaxially oriented laminated polyester film of claim 2, wherein the film comprises a base film for a dye sublimation thermal transfer ribbon.

11. The biaxially oriented laminated polyester film of claim 3, wherein the film comprises a base film for a dye sublimation thermal transfer ribbon.

12. The biaxially oriented laminated polyester film of claim 4, wherein the film comprises a base film for a dye sublimation thermal transfer ribbon.

13. The biaxially oriented laminated polyester film of claim 5, wherein the film comprises a base film for a dye sublimation thermal transfer ribbon.
